(19) United States
(12) Patent Application Publication
(10) Pub. No.: US 2025/0013708 A1
(43) Pub. Date: Jan. 9, 2025

(54) INFORMATION PROCESSING SYSTEM, METHOD OF CONTROLLING INFORMATION PROCESSING SYSTEM, AND STORAGE MEDIUM

(71) Applicant: CANON KABUSHIKI KAISHA, Tokyo (JP)

(72) Inventor: KENICHI HIROSE, Kanagawa (JP)

(21) Appl. No.: 18/737,982

(22) Filed: Jun. 8, 2024

(30) Foreign Application Priority Data
Jul. 4, 2023 (JP) 2023-109876

(51) Int. Cl. G06F 16/958; G06F 40/10

(52) U.S. Cl. CPC G06F 16/958; G06F 40/10

(57) ABSTRACT

An information processing system includes at least one memory and at least one processor which function as: an obtaining unit configured to obtain a name of each of a plurality of display targets; and a control unit configured to perform control based on the names obtained by the obtaining unit to categorize and display the plurality of the display targets such that, among the plurality of the display targets, the display targets having a same first portion in the respective names are a same group at a first tier, and among the plurality of the display targets included in the same group at the first tier, the display targets having a same second portion in the respective names are in a same group at a second tier situated one tier lower than the first tier.

### BACKGROUND OF THE INVENTION

### Field of the Invention

The present disclosure relates to a technique for listing a group of candidate display targets.

### Description of the Related Art

In typical web sites that provide individual web pages for each product, in order to guide a user to a Web page of a target product, a web page (hereinafter, referred to as “product name selection screen”) that displays a list of a list of product name buttons linked to the web page for each product is provided. There have been techniques for displaying such a product name selection screen in which, in a case where each product name is formed of a character string including an alphabetical character string, the product names are grouped by their alphabetical character strings, and product name buttons are listed in these groups and displayed. Japanese Patent Laid-Open No. H10-312267 discloses a technique in which character strings including alphanumeric characters are grouped by their alphabetical character strings, and the grouped character strings are sorted by the numerical portions in the character strings. Japanese Patent Laid-Open No. 2008-123239 discloses a technique in which keywords are extracted from contents and, in a case where the number of candidates is large, are grouped and the grouped keywords are hierarchically presented.

### SUMMARY OF THE INVENTION

An information processing system according to the present disclosure includes at least one memory and at least one processor which function as: an obtaining unit configured to obtain a name of each of a plurality of display targets; and a control unit configured to perform control based on the names obtained by the obtaining unit to categorize and display the plurality of the display targets such that, among the plurality of the display targets, the display targets having a same first portion in the respective names are a same group at a first tier, and among the plurality of the display targets included in the same group at the first tier, the display targets having a same second portion in the respective names are in a same group at a second tier situated one tier lower than the first tier.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an information processing system;

FIGS. 2A and 2B are diagrams illustrating an example of a product name selection screen;

FIG. 3 is a sequence chart illustrating a process of displaying the product name selection screen;

FIG. 4 is a table illustrating a product information list;

FIG. 5 is a table illustrating a series-ID list;

FIG. 6 is a flowchart illustrating a web page creation process;

FIG. 7 is a table illustrating a number group list;

FIG. 8 is a diagram illustrating an example of a product name selection screen in which products are displayed based on a predetermined number;

FIG. 9 is a flowchart illustrating a process of creating a web page to display products based on the predetermined number; and

FIG. 10 is a diagram illustrating an example of a product name selection screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

The embodiments disclosed below are described using examples in which each product name starts with an alphabetical character string followed by a numerical character string since product names generally tend to start with an alphabetical character string followed by a numerical character string. However, the present disclosure is not limited to this example. The present disclosure also includes cases where product names start with the other character string, such as a numerical character string, followed by an alphabetical character string, for example.

### First Embodiment

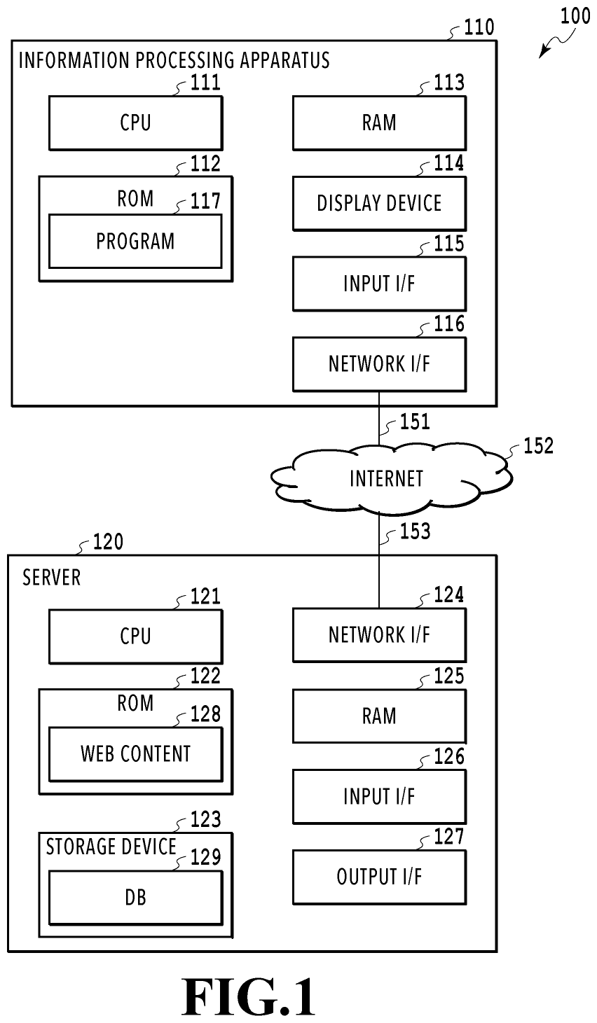

FIG. 1 is a block diagram illustrating a hardware configuration of an information processing system 100 including an information processing apparatus 110 and a server 120. The information processing apparatus 110 includes a central processing unit (CPU) 111, a read-only memory (ROM) 112, a random-access memory (RAM) 113, a display device 114, input interface (I/F) 115, and a network I/F 116. The CPU 111 loads programs stored in the ROM 112 to the RAM 113 and reads them out to execute and control various functions. The ROM 112 stores programs 117 such as a browser and the like. The browser as one of the programs 117 is a program that displays web pages on the display device 114, and can be operated by the user through the input I/F 115. The RAM 113 is used as temporary storage areas such as a main memory and a work area for the CPU 111. Note that in the present embodiment, a single CPU 111 uses a single memory (RAM 113) to execute the processes to be described later. However, the present embodiment is not limited to this configuration. For example, plural CPUs may cooperate with plural RAMs or plural storage devices to execute the processes.

The display device 114 is a device that displays the web pages mentioned above and the like, and is a liquid crystal display device or the like. The input I/F 115 is an interface that receives data inputs and operation instructions from the user and includes a physical keyboard, buttons, a touch panel, or the like. The display device 114 and the input I/F 115 may be configured of an operation panel or the like to be integrated with each other. The network I/F 116 communicates with information processing apparatuses and the like through a network, such as the Internet. The network I/F 116 may be Ethernet (registered trademark) or the like, Universal Serial Bus (USB), serial communication, or wireless communication, such as Wireless Fidelity (Wi-Fi) (registered trademark). The information processing apparatus 110 is not limited to a desktop personal computer (PC) or a laptop PC and may be a smartphone, a tablet terminal, a personal digital assistant (PDA), or the like.

The server 120 is a web server that provides web sites. The server 120 includes a CPU 121, a ROM 122, a storage device 123, a network I/F 124, a RAM 125, an input I/F 126, and an output I/F 127. The CPU 121 loads programs stored in the ROM 122 to the RAM 125 and reads them out to execute and control various functions. The ROM 122 stores web contents 128 such as web pages' HyperText Markup Language (HTML), images, and JavaScript, Hypertext Preprocessor (PHP), or the like as a program that performs a process of displaying the web pages and so on. The storage device 123 stores a database (DB) 129 such as a product information list including products to be displayed. The RAM 125 is used as temporary storage areas such as a main memory and a work area for the CPU 121. Note that in the present embodiment, a single CPU 121 uses a single memory (RAM 125) to execute the processes to be described later. However, the present embodiment is not limited to this configuration. For example, plural CPUs may cooperate with plural RAMs or storage devices to execute the processes. Here, the product information list contains the model names of printers, multi-function peripherals (MFPs), PCs, PDAs, smartphones, tablet terminals, music players, gaming consoles, digital cameras, electronic book readers, and so on.

The input I/F 126 is an interface that receives data inputs and operation instructions from the user and includes a physical keyboard, buttons, a touch panel, or the like. The output I/F 127 is an interface for outputting various data and information. The input I/F 126 and the output I/F 127 may be configured as a single component, and which the single component may output screens and receive user operations. The network I/F 124 communicates with information processing apparatuses and the like through a network, such as the Internet. The network I/F 116 may be Ethernet (registered trademark) or the like, a USB-bus, serial communication, or wireless communication such as Wi-Fi (registered trademark). In the present embodiment, the information processing apparatus 110 and the server 120 are capable of communicating with each other through an Internet 152.

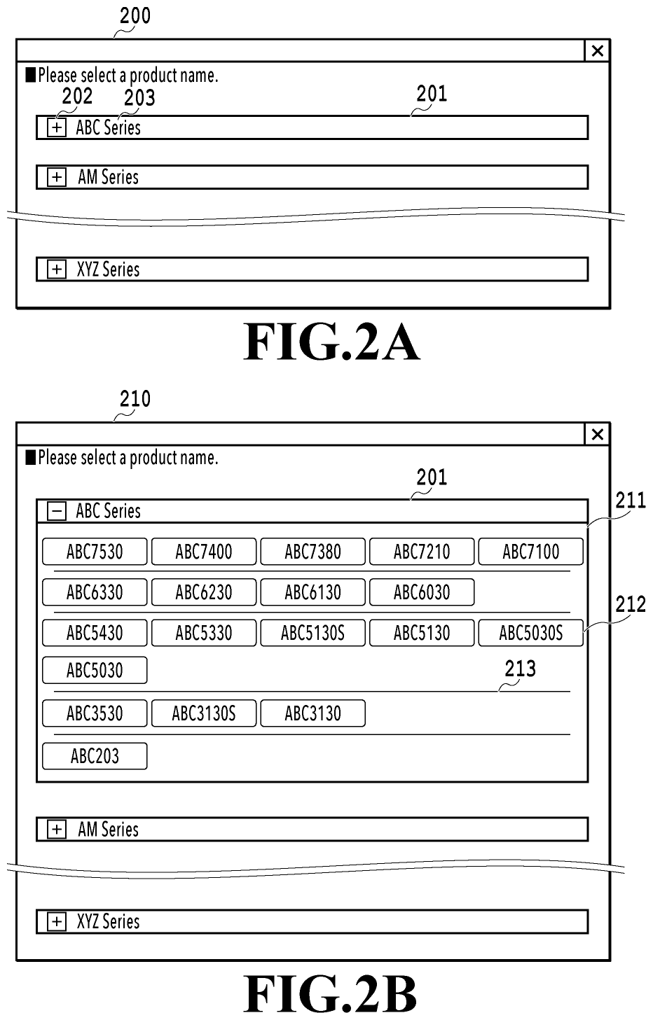

In the present embodiment, a description will be given the flow of processing in which the program which is one of the web contents 128 in the server 120 groups and displays product select buttons in a product name selection screen to be displayed by the browser which is one of the programs 117 in the information processing apparatus 110. Processing in the present embodiment will be described in detail below using FIGS. 2A, 2B, 3, 4, 5, 6, and 7.

FIG. 2A is a diagram of a product name selection screen 200 (accordion closed) representing an example of a browser to be displayed on the display device 114 of the information processing apparatus 110. The product name selection screen 200 includes an accordion 201. The screen with the accordion 201 closed is illustrated. The accordion 201 includes an open-close button 202 and a title 203. The open-close button 202 has a function of opening and closing the accordion 201, and displays “+” in the state where the accordion 201 is closed and displays “−” in the state where the accordion 201 is open. In an initial display state, the accordion 201 may be either open or closed. FIG. 2B is a diagram of a product name selection screen 210 (accordion opened). The product name selection screen 210 represents the product name selection screen 200 in a case where the accordion 201 is open, and includes the accordion 201 and a group display content section 211. The group display content section 211 includes product select buttons 212 and separators 213. The separators 213 are optional elements and may not be displayed.

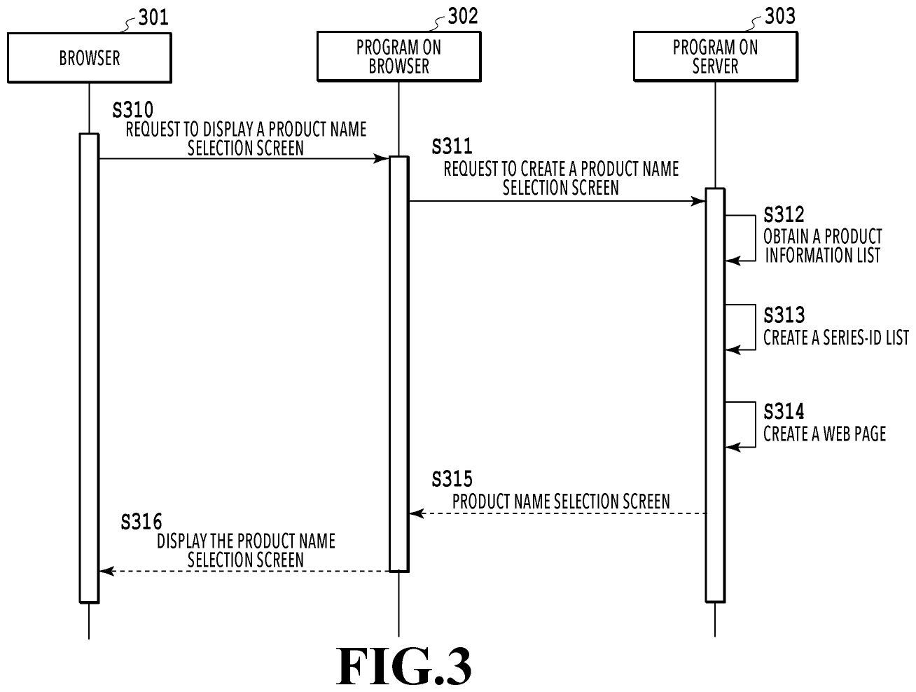

FIG. 3 is a sequence chart illustrating a process of displaying the product name selection screen indicating processing up to a point where the product name selection screen 200 is displayed on a browser 301. The browser 301 is one of the programs 117 stored in the ROM 112 of the information processing apparatus 110. An on-browser program 302 is a program that is downloaded into the RAM 113 of the information processing apparatus 110 from the web contents 128 stored in the ROM 122 of the server 120 along with a web site and operates on the browser 301. The on-browser program 302 is a program such as JavaScript (registered trademark), for example, and performs a process of displaying web pages on the browser 301 and the like. A program 303 on the server 120 is a program 128 that operates on the server 120. The program 303 on the server 120 is a program such as PHP, for example, and performs a process of creating a web page to be used in the web page display process to be performed by the on-browser program 302 and the like.

In S310, in a case where the user inputs the uniform resource locator (URL) of a product name selection screen page stored in the web contents 128 in the server 120 into the browser 301, the CPU 111 of the information processing apparatus 110 performs the following process. The CPU 111 of the information processing apparatus 110 requests the server 120 (the on-browser program 302) through the browser 301 to display the product name selection screen page. In a case where the CPU 121 of the server 120 receives the request to display the product name selection screen page from the information processing apparatus 110, the processing proceeds to S311. In S311, the CPU 121 of the server 120 issues an instruction as a request to create a product name selection screen to the program 303 on the server 120 through the on-browser program 302. In a case where the CPU 121 of the server 120 receives the request to create a product name selection screen through the program 303 on the server 120, the processing proceeds to S312.

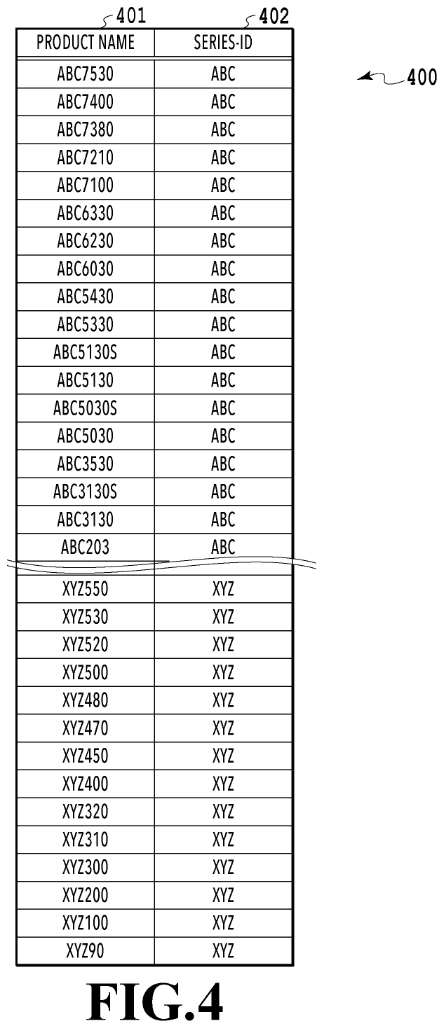

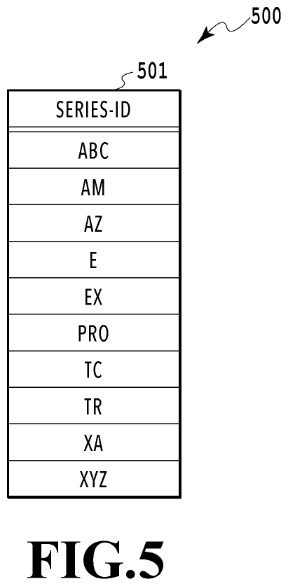

In S312, the CPU 121 of the server 120 obtains a product information list 400 illustrated in FIG. 4 from the DB 129 stored in the storage device 123 through the program 303 on the server 120. After the product information list 400 is obtained, the processing proceeds to S313. The product information list 400 includes information of product names 401 and series-IDs 402. In S313, the CPU 121 of the server 120 extracts non-identical character strings one by one from the series-IDs 402 of the product information list 400 through the program 303 on the server 120. The CPU 121 of the server 120 sorts the extracted group of character strings in natural sort order and creates a series-ID list 500 illustrated in FIG. 5. After the series-ID list 500 is created, the processing proceeds to S314. The series-ID list 500 includes information of series-IDs 501 and is stored in the RAM 125 of the server 120. In the example of FIG. 5, the series-IDs 501 are formed of alphabetical character strings. In S314, the CPU 121 of the server 120 executes a process of creating a web page through the program 303 on the server 120. The processes of S313 to S314 in the present embodiment are executed by the program 303 on the server 120, but these processes may be executed by the on-browser program 302.

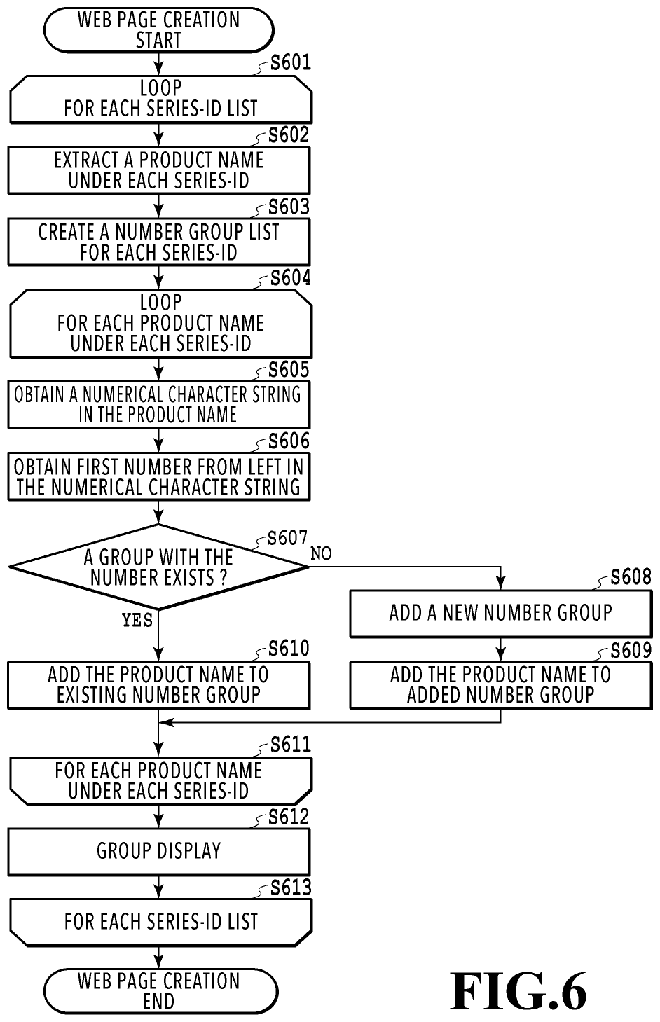

The web page creation process executed in S314 will be described in detail with reference to the flowchart of FIG. 6. FIG. 6 is a flowchart illustrating the processing from the start to the end of the web page creation by the CPU 121 of the server 120 through the program 303 on the server 120. In S601, the CPU 121 of the server 120 iterates the following processes sequentially for each series-ID list 500 created in S313 through the program 303 on the server 120. In S602, the CPU 121 of the server 120 compares the series-IDs 501 in the series-ID list 500 and the series-IDs 402 in the product information list 400 and extracts all of the matched product name(s) 401 through the program 303 on the server 120. After all of the product name(s) 401 are extracted, the processing proceeds to S603.

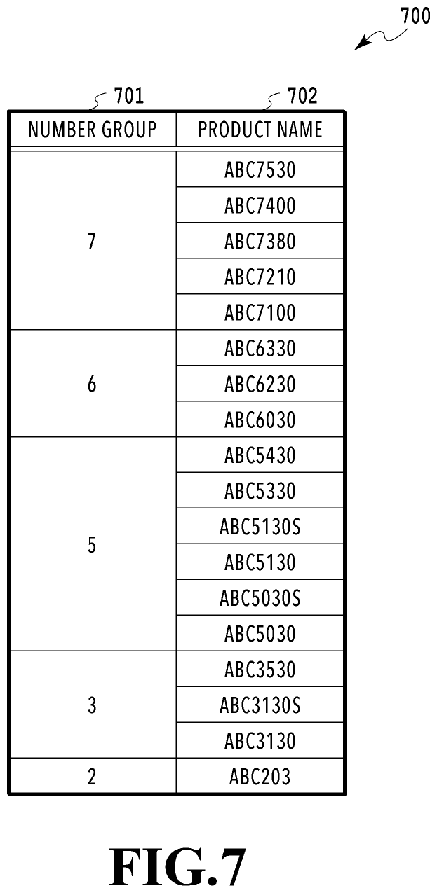

In S603, the CPU 121 of the server 120 creates an empty number group list 700 for each series-ID 501 through the program 303 on the server 120. After the empty number group list 700 is created, the processing proceeds to S604. Here, the number group list 700 illustrated in FIG. 7 includes information of number groups 701 and product names 702. The CPU 121 of the server 120 iterates the following processes sequentially for each of the product names 401 extracted in S602 through the program 303 on the server 120.

In S605, the CPU 121 of the server 120 obtains the numerical character string included in the product name through the program 303 on the server 120. After the numerical character string included in the product name is obtained, the processing proceeds to S606. In S606, the CPU 121 of the server 120 obtains the first number from the left in the numerical character string through the program 303 on the server 120. After the first number from the left in the numerical character string is obtained, the processing proceeds to S607. The processes of S605 and S606 will now be described using one example. In a case where the product name is, for example, “ABC7350”, the CPU 121 of the server 120 obtains the numerical character string “7350” in S605 through the program 303 on the server 120. The character string “ABC”, which is obtained as the series-ID 501 before the numerical character string “7350” is obtained, is an alphabetical character string. The alphabetical character string “ABC” and the numerical character string “7350” are both in the same group, and the numerical character string “7350” is categorized as a character string at a tier that is one tier lower than the alphabetical character string “ABC”. Then, in S606, the CPU 121 of the server 120 obtains the first number “7” from the left, which is a part of the numerical character string “7350”, through the program 303 on the server 120.

In S607, the CPU 121 of the server 120 determines whether the number obtained in S606 exists among the number groups 701 in the number group list 700 through the program 303 on the server 120. In a case where it is determined in S607 that a group with the number already exists, the processing proceeds to S610. In a case where it is determined in S607 that a group with the number does not exist, the processing proceeds to S608. In S608, the CPU 121 of the server 120 adds a new number group to the number groups 701 through the program 303 on the server 120, and the processing proceeds to S609. In S609, the CPU 121 of the server 120 adds the product name to the added number group through the program 303 on the server 120, and the processing proceeds to S611. In S610, the CPU 121 of the server 120 adds the product name to the existing number group 701 through the program 303 on the server 120, and the processing proceeds to S611. In S611, the processing returns to S604 in a case where the iteration process from S604 has not been finished. The processing proceeds to S612 in a case where the iteration process from S604 has been finished.

In S612, the CPU 121 of the server 120 performs a group display processing through the program 303 on the server 120, and the processing proceeds to S613. The processing of S612 will now be described in detail. The CPU 121 of the server 120 creates the accordion 201 and the group display content section 211 in the product name selection screen 210 through the program 303 on the server 120. The CPU 121 of the server 120 displays the product names 702 as the product selection button(s) 212 for each group of the number groups 701 of the group list 700 in the group display content section 211 through the program 303 on the server 120. The CPU 121 of the server 120 also displays the separators 213 as delimiters for each group in the group display content section 211 through the program 303 on the server 120 (see FIG. 2B). The CPU 121 of the server 120 closes the accordion 201 in the product name selection screen 210 through the program 303 on the server 120 to bring the product name selection screen 210 to the state indicated by the product name selection screen 200 (see FIG. 2A). In S613, the processing returns to S601 in a case where the iteration process from S601 has not been finished. The flowchart illustrated in FIG. 6 ends in a case where the iteration process from S601 has been finished.

Now, refer back to the sequence for displaying a product name selection screen in FIG. 3. After the process of S314 is completed, the processing proceeds to S315. In S315, the CPU 121 of the server 120 returns a web page with the product name selection screen 200 to the on-browser program 302 through the program 303 on the server 120. In a case where the on-browser program 302 receives the web page with the product name selection screen 200, the processing proceeds to S316. In S316, the CPU 121 of the server 120 displays the web page with the product name selection screen 200 on the browser 301 of the information processing apparatus 110 through the on-browser program 302. In a case where the web page with the product name selection screen 200 is displayed on the browser 301 of the information processing apparatus 110, the processing in the sequence chart illustrated in FIG. 3 ends.

According to the present embodiment, in a configuration in which a list of product names configured by a combination of an alphabetical character string (alphabetic portion) and a numerical character string (the other character type) is displayed, a display method in which the product names are grouped and displayed for each alphabetical character string is used, and the product names are further grouped and displayed by numbers. Thereby, the user can figure out the first character from the left in the numerical character string in a desired product name, and determine whether a group is the one including the desired product name from among the groups of products grouped by the numbers. By figuring out the first character from the left in each of the alphabetical character string and the numerical character string in the name of a desired product, the user can find the desired product out of the groups of products grouped by the alphabetical character strings and the numbers in their names. Accordingly, even in a case where there are many products in each group, the visibility of product displays is improved.

### Second Embodiment

In the first embodiment, a description has been given of a process in which products grouped by the alphabetical character strings in their names and displayed are further grouped by the numbers in their names and displayed. In a second embodiment, a description will be given of a process in which products grouped by the alphabetical character strings in their names are further grouped by the numbers in their names and displayed in a case where the number of products grouped by the alphabetical character strings is a predetermined number or more (a threshold value or more). The present embodiment will be described in detail below with reference to FIGS. 3, 4, 5, 6, 7, 8, 9 and 10.

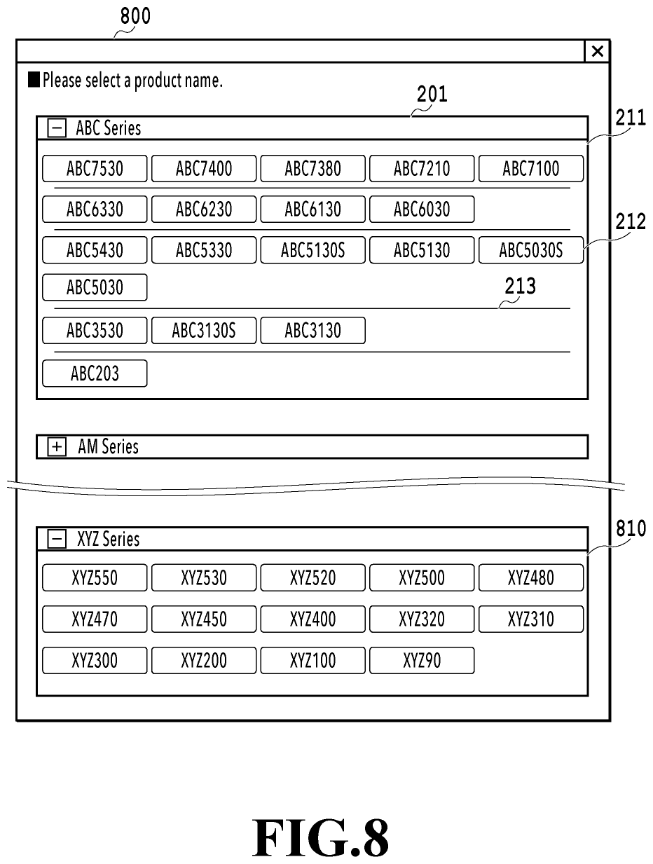

FIG. 8 is a diagram of a product name selection screen 800 in which products are displayed based on a predetermined number (threshold value), representing an example of a browser screen to be displayed on the display device 114 of the information processing apparatus 110. The present embodiment will be described on the assumption that the predetermined number (threshold value) is 15. The product name selection screen 800 includes an accordion 201, a group display content section 211, and a sequential display content section 810. The group display content section 211 includes product select buttons 212 and separators 213. The separators 213 are optional elements and may not be displayed. The sequential display content section 810 includes product select buttons 212.

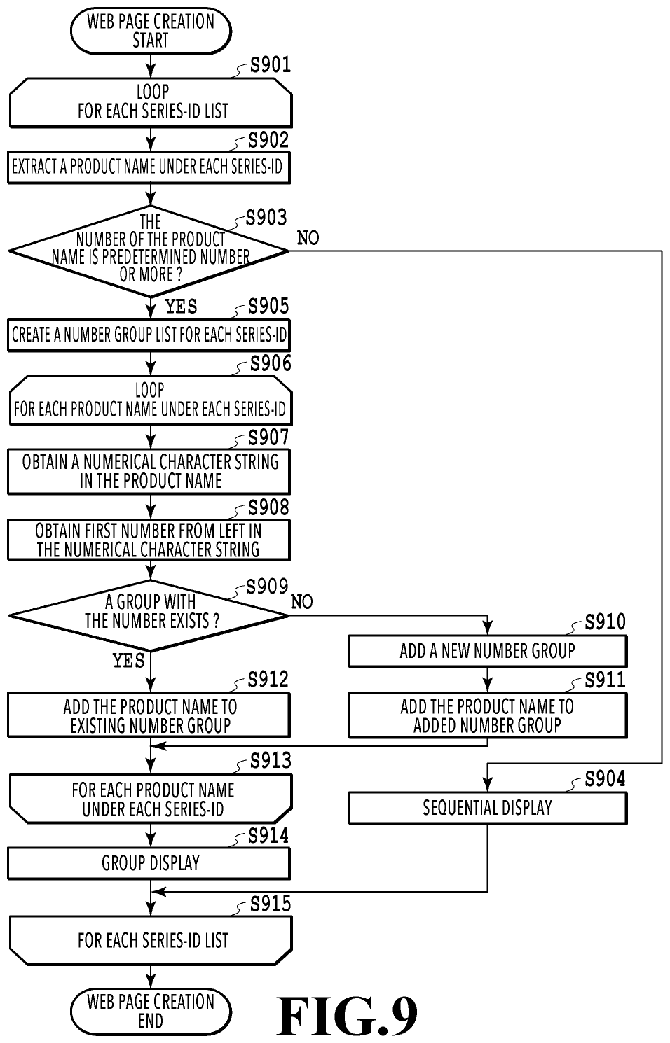

The present embodiment will be described with reference to FIG. 3. Since the processes of S310 to S313 are the same as those in the first embodiment, description thereof is omitted in the present embodiment. After completing the processes up to S313, in S314, the CPU 121 of the server 120 executes a process of creating a web page through the program 303 on the server 120. The web page creation process will now be described in detail with reference to FIG. 9.

FIG. 9 is a flowchart illustrating the processing from the start to the end of the displaying of the product name buttons by the CPU 121 of the server 120 through the program 303 on the server 120. In S901, the CPU 121 of the server 120 iterates the following processes sequentially for each series-ID list 500 created in S313 through the program 303 on the server 120. In S902, the CPU 121 of the server 120 compares the series-IDs 501 in the series-ID list 500 and the series-IDs 402 in the product information list 400 and extracts all of the matched product name(s) 401 through the program 303 on the server 120. After all of the product name(s) 401 are extracted, the processing proceeds to S903.

In S903, the CPU 121 of the server 120 determines whether or not the number of the product names 401 extracted in S902 is a predetermined number or more (a threshold value or more) through the program 303 on the server 120. The predetermined number (threshold value) is a value defined by the web contents 128 in the server 120. The predetermined number (threshold value) may be a value automatically calculated according to dimensions of display areas such as the window width of the group display content section 211 and the button width of the product select buttons 212. In a case where it is determined that the number of the product name(s) 401 extracted by the CPU 121 of the server 120 in S902 is less than the predetermined number (less than the threshold value), the processing proceeds to S904. In a case where it is determined that the number of the product name(s) 401 extracted by the CPU 121 of the server 120 in S902 is the predetermined number (threshold value) or more, the processing proceeds to S905.

In S904, the CPU 121 of the server 120 performs a sequential display process through the program 303 on the server 120. The sequential display process will now be described. The CPU 121 of the server 120 creates the accordion 201 and the sequential display content section 810 in the product name selection screen 800 through the program 303 on the server 120. The CPU 121 of the server 120 displays the product select buttons 212 in the sequential display content section 810 through the program 303 on the server 120 in such a manner that the product select buttons 212 are displayed in the order of the product names obtained in S902 (see FIG. 8). In a case where the above display manner is designated and the product select buttons 212 are displayed in that manner in the sequential display content section 810, the processing proceeds to S915.

In S905, the CPU 121 of the server 120 creates an empty number group list 700 for each series-ID 501 through the program 303 on the server 120. After the empty number group list 700 is created, the processing proceeds to S906. The CPU 121 of the server 120 iterates the following processes sequentially for each of the product names 401 extracted in S905 through the program 303 on the server 120. In S907, the CPU 121 of the server 120 obtains the numerical character string included in the product name through the program 303 on the server 120. After the numerical character string included in the product name is obtained, the process proceeds to S908. In S908, the CPU 121 of the server 120 obtains the first number from the left in the numerical character string through the program 303 on the server 120. After the first number from the left in the numerical character string is obtained, the processing proceeds to S909.

In S909, the CPU 121 of the server 120 determines whether the number obtained in S909 exists among the number groups 701 in the number group list 700 through the program 303 on the server 120. In a case where it is determined in S909 that a group with the number already exists, the processing proceeds to S912. In a case where it is determined in S909 that a group with the number does not exist, the processing proceeds to S910. In S910, the CPU 121 of the server 120 adds a new number group to the number groups 701 through the program 303 on the server 120, and the processing proceeds to S911. In S911, the CPU 121 of the server 120 adds the product name to the added number group through the program 303 on the server 120, and the processing proceeds to S913. In S912, the CPU 121 of the server 120 adds the product name to the existing number group 701 through the program 303 on the server 120, and the processing proceeds to S913. In S913, the processing returns to S906 in a case where the iteration process from S906 has not been finished. The processing proceeds to S914 in a case where the iteration process from S906 has been finished.

In S914, the CPU 121 of the server 120 performs a group display process through the program 303 on the server 120, and the processing proceeds to S915. In S915, the processing returns to S901 in a case where the iteration process from S901 has not been finished. The flowchart illustrated in FIG. 9 ends in a case where the iteration process from S901 has been finished.

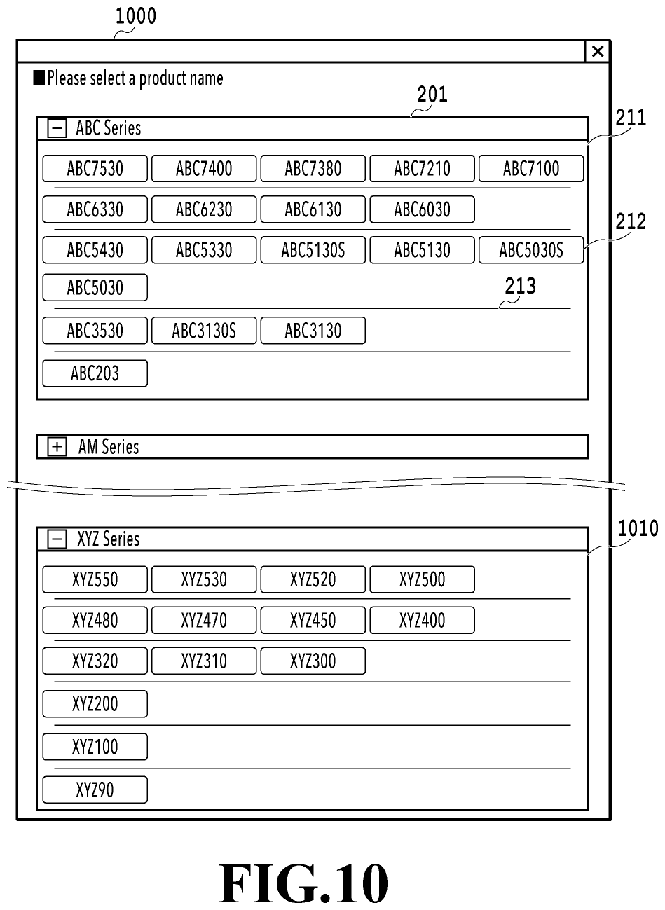

A specific example will now be described with reference to FIG. 4. The threshold value at the branch S903 in the present embodiment is 15. As shown in FIG. 4, has the series-ID “ABC” has 16 products, and the series-ID “XYZ” has 14 products. In the case of the first embodiment, the product list for the series-ID “XYZ” is display in six rows in the vertical direction, as illustrated in FIG. 10. Since the display of the product names is long in the vertical direction, a long display area is necessary to display all products including those with the other series-IDs. The user will need to operate a scrollbar or the like to display the button for a desired product, which is troublesome for the user.

In a case of using the method of the present embodiment, the processes from S905 are executed for the products with the series-ID “ABC” since the number of those products is 16 and is more than the threshold value at the branch S903. On the other hand, for the products with the series-ID “XYZ”, the process of S904 is executed since the number of those products is 14 and is less than the threshold value. As a result, the product list illustrated in FIG. 8 is displayed. With the method of the present embodiment too, the user can figure out the first character in each of the alphabetical character string and the numerical character string in the name of a desired product. Accordingly, the visibility of product displays is improved. Further, for each series-ID, the display method is switched based on the number of products with the series-ID. This makes it possible to display products in a small number of rows for a series-ID with a small number of products. As compared with the case of the first embodiment described above, the product list for the series-ID “XYZ” is displayed in three rows in the vertical direction, as illustrated in FIG. 8. Accordingly, all products including those with the other series-IDs are displayed within a shorter display area. This allows the user to display the button for a desired product without having to operate a scrollbar or the like, and therefore reduces the burden of operation on the user.

Note that the above various types of control described to be performed by the CPU 121 of the server 120 may be performed by a single piece of hardware, or the processing may be distributed and shared by plural pieces of hardware (e.g., plural processors or circuits) to control the whole apparatus.

### Other Embodiments

The above-described embodiment(s) of the present disclosure can be realized by performing the following process. A recording medium to which program code of software for realizing the functions of the above-described embodiments is recorded is supplied to an information processing apparatus or a server. Then, the information processing apparatus or the server (or a central processing unit (CPU)) reads and executes the program code stored in the recording medium. Accordingly, the above-described functions can be realized. In this case, the program code read from the recording medium realizes the functions of the above-described embodiments, and the recording medium that stores the program code constitutes the present disclosure.

As the recording medium for supplying the program code, for example, a flexible disk, a hard disk, an optical disk, a magneto-optical disk, a compact disc read-only memory (CD-ROM), a compact disc recordable (CD-R), a magnetic tape, a nonvolatile memory card, a ROM, or a digital versatile disc (DVD) can be used.

The present disclosure includes not only a case where the functions of the above exemplary embodiments are achieved by executing a program code read by a computer, but also a case where based on an instruction from the program code, an operating system (OS) operating on the computer performs a part or all of actual processing, and the functions of the above-described exemplary embodiments are achieved by the processing.

Further, the program code read from the recording medium may be written to a memory included in a function extension board that is inserted into the computer or a memory included in a function extension unit that is connected to the computer. Then, a CPU and the like included in the function extension board or a CPU and like included in the function extension unit may perform part or all of the actual processing. With the processing, the functions of the above-described embodiments of the present disclosure are realized.

Further, the information processing apparatus can be supplied with the program not only on the Internet but also via a communication way such as a LAN or private line.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-109876, filed Jul. 4, 2023, which is hereby incorporated by reference wherein in its entirety.

What is claimed is:

1. An information processing system, comprising at least one memory and at least one processor which function as:
an obtaining unit configured to obtain a name of each of a plurality of display targets; and
a control unit configured to perform control based on the names obtained by the obtaining unit to categorize and display the plurality of the display targets such that
among the plurality of the display targets, the display targets having a same first portion in the respective names are a same group at a first tier, and
among the plurality of the display targets included in the same group at the first tier, the display targets having a same second portion in the respective names are in a same group at a second tier situated one tier lower than the first tier.

2. The information processing system according to claim 1, wherein the names of the plurality of the display targets each includes an alphabetical portion and a portion of the other character type, and the first portion is the alphabetical portion.

3. The information processing system according to claim 2, wherein the second portion is a part of a head portion in the portion of the other character type.

4. The information processing system according to claim 3, wherein the other character type is a numerical character.

5. The information processing system according to claim 3, wherein the names of the plurality of the display targets are each a character string in which the alphabetical portion is followed by the portion of the other character type.

6. The information processing system according to claim 1, wherein in a case where the plurality of the display targets are categorized and displayed by the control unit, the plurality of the display targets belonging to the same group at the second tier are displayed even without an operation that designates the second tier.

7. The information processing system according to claim 1, wherein in a case where the plurality of the display targets are categorized and displayed by the control unit, the plurality of the display targets belonging to the same group at the second tier are displayed in response to an operation that designates the second tier.

8. The information processing system according to claim 1, wherein
the control unit performs control such that the display targets are subjected to the categorization at the second tier and displayed in a case where the number of the display targets belonging to the same group at the first tier is a threshold value or more, and
the control unit performs control such that the display targets are displayed without being subjected to the categorization at the second tier in a case where the number of the display targets belonging to the same group at the first tier is less than the threshold value.

9. The information processing system according to claim 8, wherein a plurality of display targets which are included in a first group at the first tier and are to be displayed after being subjected to the categorization at the second tier and a plurality of display targets which are included in a second group at the first tier and are to be displayed without being subjected to the categorization at the second tier are both displayed.

10. The information processing system according to claim 8, wherein the threshold value varies depending on a size of a display area in which the plurality of the display targets are displayed.

11. The information processing system according to claim 1, wherein the names of the plurality of the display targets are each a model name of a product.

12. The information processing system according to claim 11, wherein the product is a printer.

13. A method of controlling an information processing system, comprising:
obtaining a name of each of a plurality of display targets; and
performing control based on the names obtained in the obtaining to categorize and display the plurality of the display targets such that
among the plurality of the display targets, the display targets having a same first portion in the respective names are a same group at a first tier, and
among the plurality of the display targets included in the same group at the first tier, the display targets having a same second portion in the respective names are in a same group at a second tier situated one tier lower than the first tier.

14. A non-transitory computer readable storage medium storing a program which causes a computer to execute a method of controlling an information processing system, the method comprising:
obtaining a name of each of a plurality of display targets; and
performing control based on the names obtained in the obtaining to categorize and display the plurality of the display targets such that
among the plurality of the display targets, the display targets having a same first portion in the respective names are a same group at a first tier, and
among the plurality of the display targets included in the same group at the first tier, the display targets having a same second portion in the respective names are in a same group at a second tier situated one tier lower than the first tier.
